(19) United States
(12) Patent Application Publication
(10) Pub. No.: US 2006/0182584 A1
(43) Pub. Date: Aug. 17, 2006

(54) Lift for a kitchen

(76) Inventor: Gerrit Ophuis, HENGELO (NL)

Correspondence Address: PILLSBURY WINTHROP SHAW PITTMAN LLP, 1650 TYSONS BOULEVARD, MCLEAN, VA, 22102, US

(21) Appl. No.: 10/527,600

(22) PCT Filed: Sep. 19, 2003
(86) PCT No.: PCT/NL03/00650

§ 371 Date: Oct. 4, 2005

(30) Foreign Application Priority Data
Sep. 20, 2002 (NL) 1021503

(51) Int. Cl. B64F 5/00

(52) U.S. Cl. 414/589

(57) ABSTRACT

The invention relates to a device for lifting and positioning objects such as a kitchen worktop or kitchen cabinet, which device comprises: a frame, a support surface arranged on the frame for displacement in vertical direction; lifting means for displacing the support surface in vertical direction. Using such a device a kitchen worktop or cabinet can easily be lifted and positioned at the correct height.

The invention relates to a device for lifting and positioning objects such as a kitchen worktop or kitchen cabinet.

The fitting of a kitchen is hard work. Worktops, particularly those of natural stone, can weigh many tens of kilos. Handling and positioning such a worktop is particularly difficult because of its weight. Upper cabinets, which can easily weigh more than 10 kilos, are also difficult to position and arrange because of the height.

It is an object of the invention to provide a device wherein the above stated drawbacks are alleviated, or even avoided.

This object is achieved with a device according to the invention, which device comprises:

a frame,

a support surface arranged on the frame for displacement in vertical direction;

lifting means for displacing the support surface in vertical direction.

A worktop can for instance be placed on the support surface, whereafter it can be displaced in vertical direction with the lifting means and can be positioned such that the worktop can be shifted onto the cabinets.

In a preferred embodiment the support surface is pivotable between a vertical and horizontal position. A worktop can for instance thus be transported to the kitchen in vertical position and then pivoted into the horizontal position in order to thus be positioned in vertical direction to allow placing on the cabinets.

Bearings are herein preferably arranged in the support surface, whereby the worktop or other object can slide easily over the support surface.

In another preferred embodiment of the device according to the invention, the support surface comprises a standing supporting edge on one side. This supporting edge can serve as boundary of the support surface, although if the support surface is pivotable this support surface then also serves to support the object, such as a worktop.

In yet another embodiment of the device according to the invention, the lifting means comprise at least one hydraulic cylinder. Such a hydraulic cylinder can be easily operated by hand or by foot to thus lift or lower the support surface.

The frame is preferably further provided with castors. The device can thus be readily displaced in any desired direction.

Yet another embodiment according to the invention comprises a lever arranged on the frame for pivoting with one end and with one part resting on the support surface. It is thus possible to attach an object to the free end of the lever and, by vertical displacement of the support surface, to displace the object over a greater distance in vertical direction. This is particularly advantageous in positioning and placing of upper cabinets of a kitchen.

A supporting table is preferably arranged on the other, free end of the lever. The object can then be placed hereon. The supporting table is preferably arranged pivotally and connected to the frame via a parallelogram construction. This ensures that the supporting table always retains a fixed orientation, for instance a horizontal orientation, irrespective of the vertical displacement.

In a preferred embodiment the orientation of the supporting table is here adjustable.

Yet another embodiment of the device according to the invention comprises at least one stabilizer bar arranged on the frame. The stability of the device is improved with this stabilizer bar. Particularly when positioning long and heavy objects, such as a kitchen worktop, or if a lever is used, it is important from a safety viewpoint that the stability of the device is increased.

These and other features of the invention are further elucidated with reference to the annexed drawings.

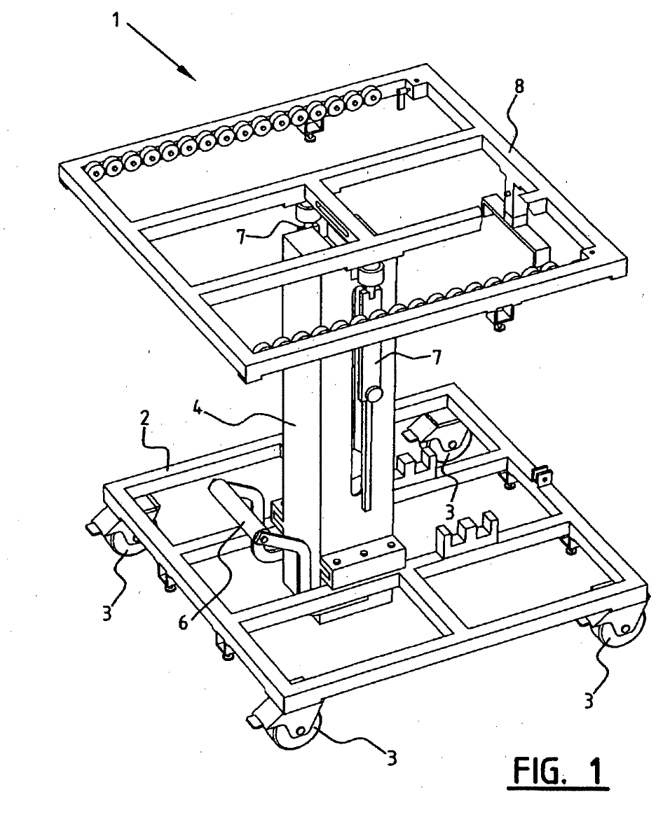

FIG. 1 shows a perspective view of a first embodiment of the device according to the invention.

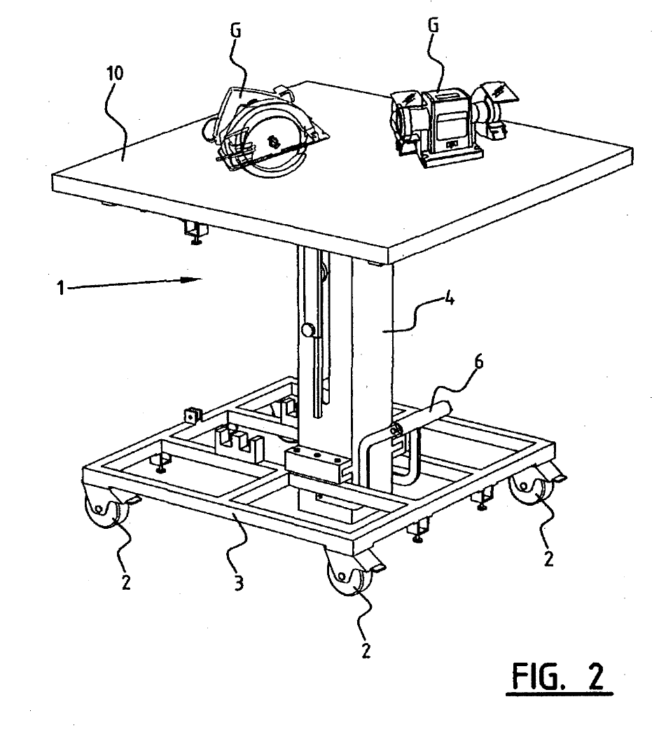

FIG. 2 shows a perspective view of the device according to FIG. 1 provided with a worktop.

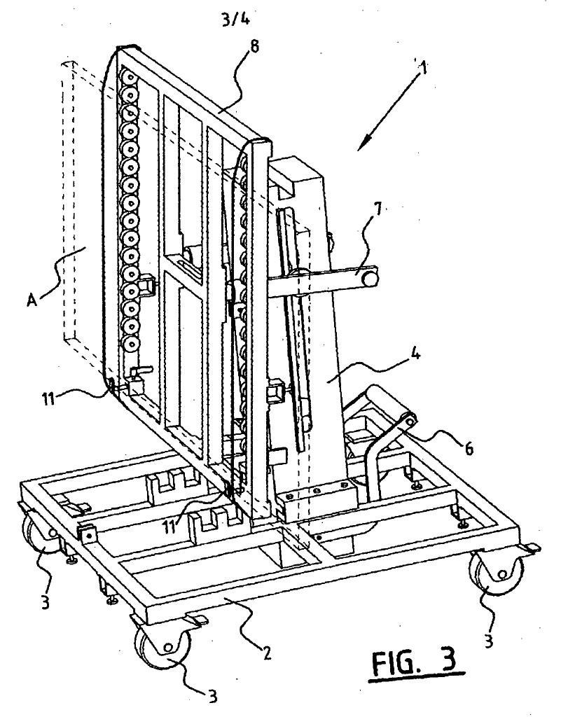

FIG. 3 shows the device according to FIG. 1 from a second viewpoint.

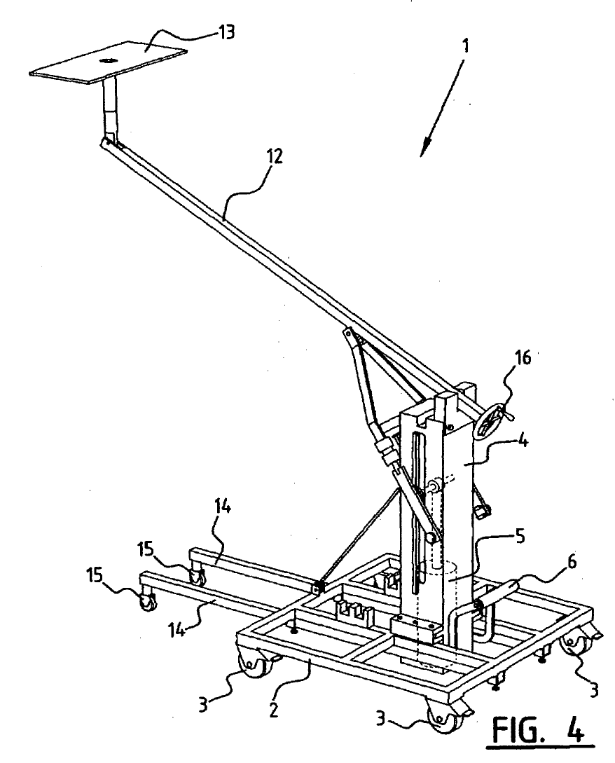

FIG. 4 shows a perspective view of the device according to FIG. 1, provided with a stabilizer bar and lever.

FIG. 1 shows an embodiment of device 1. This device 1 has a frame 2 on which are arranged four swivel castors 3. Arranged on frame 2 is a vertical column 4 in which a hydraulic cylinder 5 (see FIG. 4) is arranged. This hydraulic cylinder 5 can be operated by means of a pedal 6. A support surface 8 is arranged on hydraulic cylinder 5 by means of pivot arms 7. Support surface 8 can thus be displaced in vertical direction by operating the pedal 6.

Rollers are arranged in the edge of support surface 8 so that an object placed on support surface 8 can be readily shifted over support surface B.

FIG. 2 shows the device 1, wherein a worktop 10 is placed on the support surface. The device can thus also be used as workbench, and tools G can be placed on worktop 10.

FIG. 3 shows device 1 once again, but in a different position. In this figure the support surface 8 is pivoted to a vertical position via pivot arms 7. On support surface 8 are provided supporting pins 11, which form a supporting edge on which a kitchen worktop can for instance be placed. Kitchen worktop A can thus be transported by means of device 1. The kitchen worktop A can further be displaced in vertical direction by operating pedal 6.

In FIG. 4 the support surface 8 of device 1 has been removed and an arm is placed on the connecting part for the support surface, which arm is coupled to a lever 12 which is arranged pivotally with one end on column 4. A supporting table 13 is arranged on the free end of lever 12. By now displacing the connecting part in vertical direction via pedal 6, the carrying surface 13 is displaced in vertical direction via the lever action of lever 12. It is thus possible to also lift and position upper cabinets.

Stabilizer bars 14 are further arranged to stabilize the device 1. These stabilizer bars 14 are also equipped with a swivel castor 15.

Further provided in lever 12 is a parallelogram construction which can be adjusted by means of wheel 16. Supporting table 13 and lever 12 form part of this parallelogram construction, whereby it is possible to set the position of supporting table 13 by means of wheel 16.

1. Device for lifting and positioning objects such as a kitchen worktop or kitchen cabinet, which comprises:
a frame,
a support surface arranged on the frame for displacement in vertical direction;
lifting means for displacing the support surface in vertical direction.

2. Device as claimed in claim 1, wherein the support surface is pivotable between a vertical and a horizontal position.

3. Device as claimed in claim 1 and 2, wherein bearings are arranged in the support surface.

4. Device as claimed in claim 1, wherein the support surface comprises a standing supporting edge on one side.

5. Device as claimed in claim 1, wherein the lifting means comprise at least one hydraulic cylinder.

6. Device as claimed in claim 1, wherein the frame is provided with swivel castors.

7. Device as claimed in claim 1, further comprising a lever arranged on the frame for pivoting with one end with a middle part resting on the support surface.

8. Device as claimed in claim 7, wherein a supporting table is arranged on the other end of the lever.

9. Device as claimed in claim 8, wherein the supporting table is arranged pivotally and connected to the frame via a parallelogram construction.

10. Device as claimed in claim 8, wherein the orientation of the supporting table is adjustable.

11. Device as claimed in claim 1, further comprising at least one stabilizer bar arranged on the frame.
